(19) United States
(12) Patent Application Publication
(10) Pub. No.: US 2009/0164601 A1
(43) Pub. Date: Jun. 25, 2009

(54) SYSTEM AND METHOD FOR PROVIDING A PRIMARY VIDEO STREAM WITH A SECONDARY VIDEO STREAM FOR DISPLAY ON AN ELECTRONIC DEVICE

(75) Inventor: Gary SWARTZ, Delta (CA)

Correspondence Address: McCarthy Tetrault LLP, Box 48, Suite #4700 Toronto Dominion Bank Tower, TORONTO, ON, M5K 1E6, CA

(73) Assignee: eyedestinations Inc.

(21) Appl. No.: 11/963,234

(22) Filed: Dec. 21, 2007

(51) Int. Cl. G06F 15/16

(52) U.S. Cl. 709/217

(57) ABSTRACT

The disclosure related to a method and a server for providing a primary image file with another image file. The method comprises: providing to a network an access link for a resource that relates to the primary image file; receiving from a remote device in the network a request for the access link; from the resource, locating and providing the primary image file to the device for display in a first area of a window in a display on the device; from the resource, locating and providing a secondary image file associated with the primary file as identified in the resource to the device in a second area of the window; and updating access statistics relating to the secondary image file based on the request for the access link.

### FIELD OF DISCLOSURE

The invention described herein relates to a system and method of providing a primary video stream with a secondary video stream for display on an electronic device. In particular, the invention described herein relates to mating a requested video stream, such as a music video or news clip, with a video on behalf of a third party source, such as an advertiser.

### BACKGROUND

A common Information Technology (IT) business model is to provide an Internet website that allows users to access the site and review and download digital content from the site. A database of the content for the website is created, maintained and made available through the website. The content is generally stored in a searchable database, or library. The database may be remotely searched through the website and content may be downloaded and viewed at a remote device through a multimedia player software program. Exemplary multimedia players include Real (trademark) player, Flash (trademark) player, Windows Media (trademark) player and QuickTime (trademark). Popular digital content that is downloaded includes music audio tracks and videos relating to music.

Revenues associated with the website may be sought by charging for downloading of content and for displaying advertisement(s) in the website. Typical advertisements include a banner advertisement that provides a notice separate from the window of the multimedia player and its skin, a video clip or slide show that precedes or proceeds the selected content or a logo that is superimposed in the frame of the movie. All three methods have flaws. For example, in the latter examples, the advertising message is permanently attached to the feature movie video, which permanently may make it difficult to change advertisements that are to be associated with the video.

There is a need for a system and method which addresses deficiencies of associating advertisements with primary movies.

### SUMMARY

In a first aspect, a method for providing a primary image file with another image file is provided. The method comprises: providing to a network an access link for a resource that relates to the primary image file; receiving from a remote device in the network a request for the access link; from the resource, locating and providing the primary image file to the device for display in a first area of a window in a display on the device; from the resource, locating and providing a secondary image file associated with the primary file as identified in the resource to the device in a second area of the window; and updating access statistics relating to the secondary image file based on the request for the access link.

In the method, the resource may be a reference movie providing a link between to primary image file and the secondary image file.

In the method, the primary and secondary image files may be streamed independently to the device.

In the method, the secondary image file may be streamed simultaneously with the first image file to the device.

In the method, the resource may contain a first pointer to a first file name for the primary image file and a second pointer to a second file name for the secondary image file.

In the method, the resource is a Uniform Resource Locator (URL).

The method may further comprise replacing the secondary image file with an alternative secondary image file as accessed by the resource by renaming a third file name for the alternative secondary image file to be the second file name.

In the method, the alternative secondary image may replace the secondary image file when meta data associated with the device indicates that the alternative secondary image matches a predetermined parameter for linking the secondary image file to the primary image file.

In a second aspect, a server for providing a primary image file with another image file through a network to a requesting device is provided. The server comprises: a first module to access a database storing primary image files, secondary image files and resources providing links among the primary and secondary image files; a second module certain functions; and a statistics module for tracking traffic statistics related to the primary files and the secondary files. The second module: provides to the network an access link for a resource of the resources that relates to the primary image file; and processes a received request for the resource from a remote device in the network. The received request is processed by: identifying the primary image file from the primary files relating to the resource; identifying a secondary file from the secondary files that is to be associated with the primary image file as identified in the resource; providing the primary image file to the device for display in a window on a display of the in a first area of a window for a display of the device; and providing the secondary image file to the device for display in a second area of the window.

In the server, the resource may be a reference movie providing a link between the primary image file and the secondary image file; and the second module may stream the secondary image file to the device independently and simultaneously from the first image file.

In the server, the resource may contain a first pointer to a first file name for the primary image file and a second pointer to a second file name for the secondary image file.

The server may further comprise a third module for managing associations for the resource and for selectively replacing the secondary image file with an alternative secondary image file as accessed by the resource by renaming a third file name for the alternative secondary image file to be the second file name.

In the server, the third module may replace the secondary image file with the alternative secondary image when meta data associated with the device indicates that the alternative secondary image matches a predetermined parameter for linking the secondary image file to the primary image file.

In the server, the third module may replace the secondary image file with the alternative secondary image when statistics from the statistics module indicates streamings of the secondary image file has exceeded a predetermined threshold.

In other aspects, various combinations of sets and subsets of the above aspects are provided.

### BRIEF DESCRIPTION OF THE DRAWINGS

Embodiments of the invention will now be described, by way of example only, with reference to the accompanying drawings, in which:

FIG. 1 is a schematic diagram of a network with a Transmission Control Protocol (TCP) server storing static web pages, including a database, and a Real-Time Streaming Protocol (RTSP) server storing primary and secondary image files providing a service to stream a combination of a selected image file and an associated secondary image file to a device connected to the network, according to an embodiment;

FIG. 2A is a schematic of an exemplary screen of a multimedia player interface generated on the device of FIG. 1 when accessing a website for the service of FIG. 1, providing a video stream without an additional video stream according to an embodiment;

FIG. 2B is a schematic of an exemplary screen of a multimedia player interface generated on the device of FIG. 1 when accessing a website for the service of FIG. 1, providing a video stream with an associated advertisement video stream according to an embodiment;

FIG. 3 is a schematic of an exemplary graphical user interface (GUI) screen of the server of FIG. 1 providing the multimedia player interface of FIG. 2B with additional advertisements in the GUI according to an embodiment;

FIG. 4 is a schematic block diagram of elements of the server of FIG. 1 according to an embodiment; and

FIG. 5 is a flowchart of exemplary processes executed by the server of FIG. 1 in selecting a final movie that retrieves a video file and an advertisement file.

### DETAILED DESCRIPTION OF AN EMBODIMENT

The description which follows and the embodiments described therein are provided by way of illustration of an example or examples of particular embodiments of the principles of the present disclosure. These examples are provided for the purposes of explanation and not limitation of those principles and of the invention. In the description which follows, like parts are marked throughout the specification and the drawings with the same respective reference numerals.

Generally, an embodiment provides a system and method of delivering a primary video stream selectively with a secondary video stream for display on a multimedia player on a screen of a display of a requesting device. The device is typically being fed the two video streams from a remote server. The device may be a personal computer, mobile phone or other electronic communication device. In one embodiment, streamed data is provided in order to be able to track and maintain individual stream downloads to multiple devices, and hence also charge a fee for such streams. If a movie is downloaded, then there is typically only a single charge for the initial download. In the field of art, video streams that are provided through a network as content viewable in a multimedia player are commonly known as “movies”. A movie may be a video clip of an action scene comprising a series of related still images captured at a regular interval (such as every 1/30 of a second). Videos provided on the internet may have different interlacing schemes. It will be appreciated that the term “movie” may be effectively interchanged with the either of the terms “video” and “image file”. However, an image file is understood to be a broader term as it may be a static image or a collection of images creating a movie.

A movie may be displayed on a requesting device through a multimedia player software program that has been installed on the resident device. In a multimedia player, the movie is presented in a window in the graphical user interface (“GUI”) of the display of the device. An icon bar below the window may provide a GUI for controls for the movie (including, “play”, “stop”, “pause”, “forward” and “reverse” commands) and/or these controls may be over-ridden. A multimedia player may have one or more “skins” associated with it to allow a user to activate customized features and GUIs for the player.

An embodiment mates a “primary” image file that has been requested by a user of the device with a “secondary” image file that is mandatory in order to view the “primary” image file. The primary image file may be provided as streaming video or as a progressive download and may be an extract from a theatrical image file, a music video, a travelogue, a live clip of a sports, music or other event, a video clip of a program (such as a documentary, TV series or an interview), a news program clip, or custom footage created by a portal relating to the service provider. The secondary movie may be provided on behalf of a third party that has a different author than the author of the primary image file. The secondary image file may be an advertisement promoting a third party's products and/or services. The secondary image file may be implemented as a pointer to an image file stored on an RTSP server or as real time streaming image file such as served by a live webcam. The two image files may be presented through a single multimedia media player. In an embodiment, the output of the multimedia player preferably cannot be controlled by the user such that he can turn off the displaying of the secondary image file.

The embodiment allows the secondary image file to be mated with the primary image file in a multimedia player generated on the requesting device. In an exemplary multimedia player, one commonly used (pixel) dimension for an image displayed in its viewer is 320 pixels (wide) by 240 pixels (high). This size provides roughly a 16:9 aspect ratio for a video. An embodiment retains a portion of the window for the primary image file and creates a larger, higher window creating an area or space for a secondary image file. The secondary image file can be positioned in the additional space created and streamed to play simultaneously with the primary image file.

During the generation of the image files, the two (or more) image files may be laid out in a viewer such that the exterior boundaries of the image files do not overlap or interfere with each other. The resulting image file(s) may be accompanied by one (or more) audio tracks. The video and audio tracks may be distributed via the internet from one or more servers that use any known transport protocol known in the art, including Real-Time Transport (RTP) and Real-Time Streaming Protocol (RTSP).

The primary and secondary files may be individually selected by the multimedia player from (separate) libraries, thereby allowing the content of one or more of the video or audio tracks preferably to be changed without it being necessary to reauthor the entire presentation. The selection and association of a particular secondary image file may be made to complement the content or source of the primary image file.

In an embodiment, one feature is to provide and maintain a website that provides content in a first library relating to a series of primary image files. User interfaces are maintained that provide catalog(s) of listings of the primary image files. The primary image files may be music videos, live video feeds, static images, or any other (visual) content that may be of interest to an audience accessing the website. When a visitor to the website wishes to view an image file from the catalog, a control is activated on his device to send a request for the image file. The request may contain a Uniform Resource Locator (URL) address that provides a link to the image file at the server. Once the command is received by the website, the website retrieves the selected image file and transmits and/or streams same to the device. However, in addition to providing the image file, the server for the website identifies a secondary image file and provides it with the selected (first) image file. As noted, the secondary image file may be an advertisement. In one provisioning scheme, the two image files are provided in a single media viewer, as noted above.

Another feature of an embodiment allows the secondary image file to be dynamically selected and provided with the primary image file. The selection of any secondary file may be based on any parameter programmed to the server, including time of day, time of year, associations or triggers with certain events (e.g. sporting events, holidays, anniversaries, etc.), statistics of the frequency of views of either or both of the primary and secondary image files. The primary and secondary movies are linked through a final movie. In one embodiment, preferably a pointer to the final movie is provided by the requesting device and the primary and secondary movies are streamed to the device. In one embodiment a final movie utilizes a hyperlink for its activation. Processes are provided at the server to track the number of times that the primary image file is streamed and that a particular secondary image is associated with a primary image file. Further information about each request to view a primary movie may also be tracked and collected, such as information relating to the viewing entity's age, gender, income, location, etc. Additionally, a billing module may be provided to track the number of views of a particular secondary image file and calculate a fee, based on an advertising rate associated with that secondary image file.

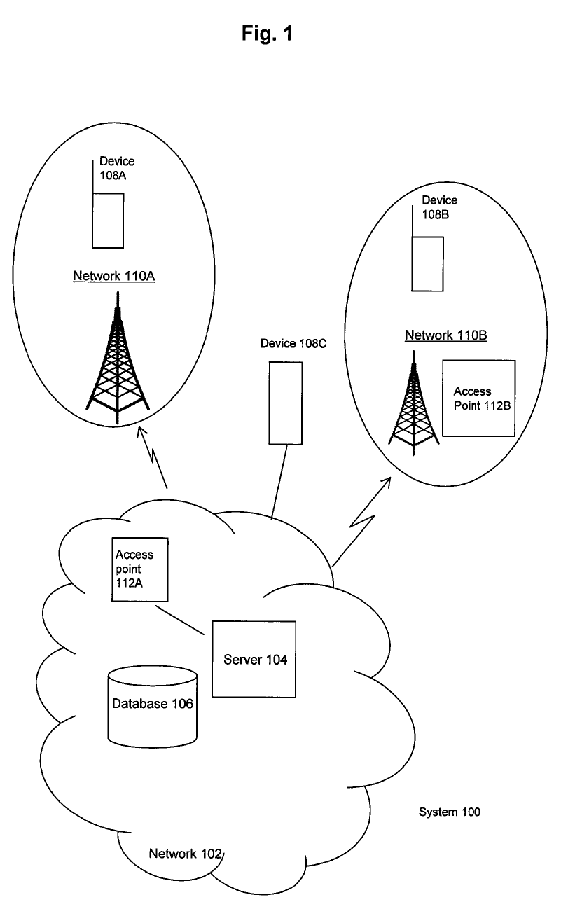

Now, further details of a network environment relating to an embodiment are provided. Referring to FIG. 1, system 100 has network 102 therein. One function of network 102 is to provide one or more communication connections for video server 104 to different devices. Additional servers, such as a Transmission Control Protocol (TCP) /IP server, RTP and RTSP servers may be provided or may be provided as part of video server 104. Network 102 is in communication with a series of linking modules and servers connect network 102 to other networks 110 and others. A Wide Access Network (WAN—not shown) may also be connected to network 102 to allow a remote device 108 to connect to network 102. Device 108C connects directly to network 102. Alternatively, private wireless network gateways, such as wireless Virtual Private Network (VPN) routers, could be implemented to provide a private interface to a wireless network.

Database 106 provides one source of video material for server 104. The video content in server 104 may be accessed by devices 108, including devices 108A, 108B and 108C through a direction connection to network 102 or through other networks 110.

Device 108 may be a wireless handheld device, cell phone, smart phone, personal digital assistant (PDA) and/or computer (either desktop or portable) having a (wireless) network card, network adapter and/or network interface controller (NIC) installed therein. Device 108 may subscribe to one or more voice or data services that are provided through one or more of network 102 or networks 110. It will be appreciated that device 108 may access server 104 through a wired connection, a wireless connection or a combination of both connections.

Device 108A connects to network 102 through network 110A. Wireless network 110A provides communication link for device 108A to network 102. Wireless network 110A may be a data-centric network, a voice-centric network, or a dual-mode network. In one embodiment, wireless network 110A is implemented as a Wi-Fi network generally following standards set by the IEEE LAN/MAN Standards Committee, known as IEEE 802, through its working group “11”. The 802.11 standard defines media access control (MAC) and physical (PHY) layers in the Open Systems Interconnection (OSI) protocol model for WLAN. Currently, the 802.11 amendments encompass six wireless modulation techniques that all use the same communication protocol among their communicating elements. Such networks are deployed in one or more of the five current versions of 802.11: 802.11a, b, g and n. Specific transmission details and parameters of these networks are known to those of skill in the art. Access point (AP) 112A in network 102 is an IEEE 802.11 radio receiver/transmitter (or transceiver) and functions as a bridge between network 110A and network 102. For security, AP 126A may be communicatively coupled to network 102 through a respective firewall and/or VPN (not shown). The AP provides data distribution services among device 108A in wireless network 110A and between devices 108 in wireless network 124 and other devices in other connected networks.

Device 108B connects to network 102 through network 110B. Cellular network 110B provides voice and data services to devices 108B. Data-centric technologies for cellular network 110B include the Mobitex (trademark) Radio Network (“Mobitex”) and the DataTAC (trademark) Radio Network (“DataTAC”). Voice-centric technologies for cellular network 110B include Personal Communication Systems (PCS) networks like Global System for Mobile Communications (GSM) and Time Division Multiple Access (TDMA) systems. Certain networks provide multiple systems. For example, dual-mode wireless networks include Code Division Multiple Access (CDMA) networks, General Packet Radio Service (GPRS) networks, and so-called third-generation (3G) networks, such as Enhanced Data rates for Global Evolution (EDGE) and Universal Mobile Telecommunications Systems (UMTS). Other network communication technologies that may be employed include, for example, Ultra Mobile Broadband (UMB), Evolution-Data Optimized (EV-DO), and High Speed Packet Access (HSPA), etc. Again administrative server (not shown) may be provided for account(s) associated with device 108B for network 110B.

Network 110B may also have an access point to connect its devices to other networks. For example, network 110B may be implemented to support General Packet Radio Service (GPRS) for a Global System for Mobile Communications (GSM) and IS-136 mobile phones. Access point 112B may provide an interface for remote data and services for devices in network 110B, including device 108B.

With connections for exemplary networks provided, further detail is now provided for an embodiment and a related service and system for downloading previously noted content from a media server 104 storing a selection of videos (image files). A subscriber at a device 108 can access the website supported by the server and make a selection for a specific image file to be downloaded to the device. When the image file is selected, the server provides the image file to the device. That image file immediately requests that two image files, a primary movie and a secondary movie, stored on an RTSP server be streamed to the multimedia player on the device.

zMultimedia player software operating on device 108 generates a GUI in which the received content is displayed on the display of the device. An interface for a multimedia media player itself may be locally generated on the device when a website for the service is accessed and when the device requests a download (or transmission of) specific audio or video content.

An account may or may not be required to be established to access the service and server. The account may or may not have an access fee associated with it. With the service, a web site is maintained that is associated with the server (or its contents).

Image files may be any type of streaming or progressively downloaded files, including video and audio tracks. However, the (final movie) files may include static images, sprites or other elements that can be generated in a standard media player. Temporary local storage of a primary image file (movie) may be provided in some embodiments. The primary image file may have an embedded flag or indicator noting that it should not be permanently saved on the downloading device. It is preferable that the primary and secondary image files be provided in separate streams. If they are combined into an integrated image file it may be difficult, impossible or impractical to separate them from each other. If the two image files remain separated, this allows different secondary image files to be selectively mated with the primary image file, provided the name of the secondary image file is retained on the server. It is notable that an embodiment “bakes” the names of two image files together, but allows a change of content, size and running time of either file. Preferably, the dimensions of the two image files are not changeable. Effectively, a proxy movie is created that initiates a search for two (or more) image files, where one of the image files relates to the originally intended content. If the first image file is encoded as a progressive movie, it may be “baked” into the proxy movie, such that the proxy movie has a primary (large) file for the target video and a pointer movie to the ancillary advertisement video.

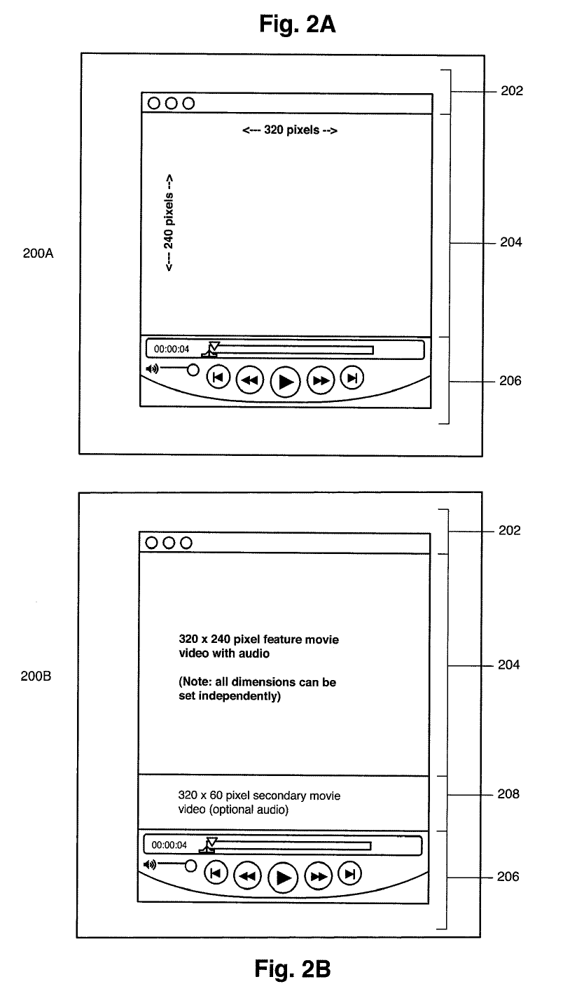

Further detail is provided on the layout of a presentation providing a primary image file with a secondary image file that is downloaded to a device. Turning now to FIGS. 1 and 2A, a schematic diagram of a streamed GUI skin providing a viewing area (screen) for a streamed video in shown at 200A. In the embodiment, a media player such as QuickTime (trademark) is activated and skin 200A is shown. Skin 200A has three display areas: Header 202 is at the top of skin 200A and provides a GUI toolbar where an “expand” and “close” icons for the window are provided, similar to other icons for other known windows in the art. Screen region 204 provides a viewing area that is defined in this instance to be 320 pixels wide by 240 pixels deep. These dimensions are a typical dimension for a 16:9 image file transmitted through the Internet. Different sizes may be defined. Player control region 206 provides a series of icons which can be activated to control the playing of the image file (including, “play”, “stop”, “pause”, “forward” and “reverse” commands). Skin 200A does not have any additional (second) image file shown therein. Preferably, the border of skin 200A is not seen when the image file is played. A request from the device to the website of the server causes an applet to be either accessed from its locally stored copy or downloaded to device 108 and skin 200A is then generated and displayed on device 108. When the “start” icon is activated (or when an embedded “start” command in initiated), the multimedia player requests a download of the selected video from server 104 and server 104 in turn provides a progressive download or stream of the selected image file to skin 200A.

Turning now to FIGS. 1 and 2B, an embodiment may provide a skin that provides a primary image file (as selected by a user of device 108) and has a secondary image file embedded with it, as shown in skin 200B. Skin 200B has the following sections that are comparable in size and function to those described in skin 200A: header 202, which is at the top of skin 200B; screen region 204, which is below header 202; and multimedia player control region 206, which is at the bottom of skin 200B. Between screen region 204 and multimedia player control region 206, second screen region 208 is provided. Second screen region 208 is provided to show a secondary image file that is streamed in coordination with a primary image file streamed to region 204. When the “start” icon is activated (or when an embedded “start” command in initiated), the multimedia player first requests a download of the selected video from server 104 and server 104 in turn provides a progressive download of the final movie which immediate requests streaming content from server 104 which streams the selected primary image file to region 204 and the secondary image (not requested by the viewer) file to region 208.

In skin 200B, first and second regions 204 and 208 provide separate viewing areas for the first and secondary image files. As such, the streamed content of the primary image file is not necessarily affected or modified by the presence of the secondary image file. In other embodiments, the second image file may be superimposed on the primary image file and may have a transparency setting adjusted to allow the underlying primary image file to be seen through the overlapping areas of the secondary image file. In such a configuration, the locations of the first and second regions 204 and 208 may be adjusted accordingly to provide some area of overlap between. The areas may completely overlap.

Referring to FIGS. 1, 3 and 4, further detail is now provided on how the content for skin 200B is selected, generated and sent from server 104 to device 108 according to an embodiment.

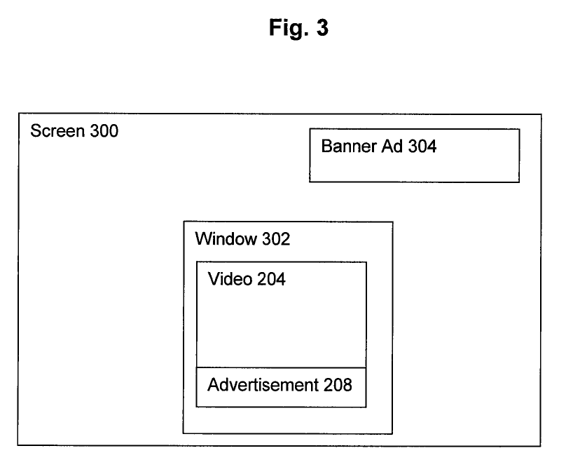

FIG. 3 is a schematic diagram of web page 300 that has been downloaded onto device 108 (FIG. 1) in accessing a web site hosted on server 104 (FIG. 1). Web page 300 shows a background page for information provided by the site. Window 302 provides a skin of a media player 200B showing a primary image file in section 204 and an advertisement in section 208. Banner advertisement 304 may be generated and displayed independently of skin 200B. In an embodiment, the background webpage may be provided from a TCP server 104. Window 302 may be generated by the locally running media player software on device 108. Image files 204 and 208 may be provided from server 104.

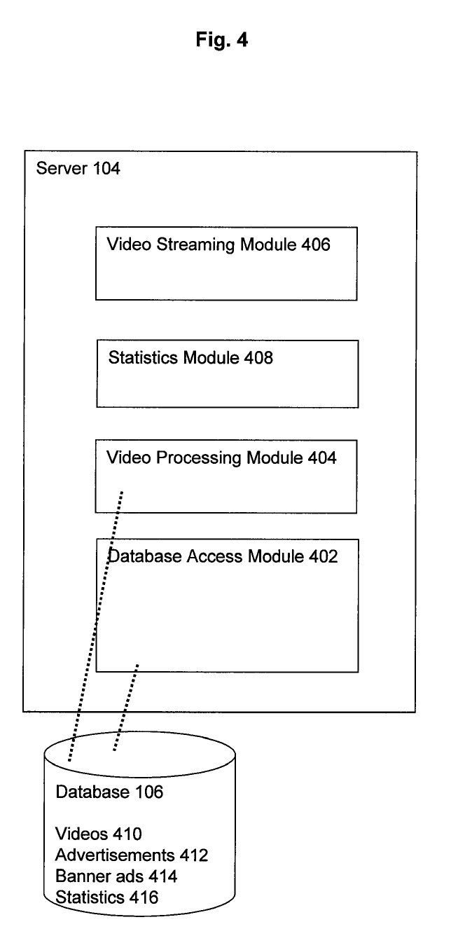

Referring to FIG. 4, contents for web page 300 are provided by server 104, which is a computer-based system having a database access module 402, video processing module 404, video selection and streaming module 406 and statistics module 408. Database access module 402 processes requests for image files and the like, initiates relevant searches in database 106 and provides results to the requesting entity. Video processing module 404 processes video files for storage into database 106. Video selection and streaming module 406 processes reference image files and templates (as described below) in generating a skin for display on a device, selecting video files from database 106 for transmission to the device per a template (as described below) and transmitting a requested streamed video from server 104. Statistics module 408 tracks and logs traffic statistics related to the website, such as statistics relating to how often an image file is viewed over a given time period, how often an advertisement has been displayed and where the advertisement has been sent, etc. These logs allow the administrator of the website to know which advertisers were sponsoring content in a given period or for a given number of page views. As such, billing details can be provided to the advertiser. As noted earlier, server 104 has access to database 108, which contains a set of primary image files 410, secondary image files 412, banner advertisement logos 414 and statistics 416.

As noted earlier, in database 108, primary image files 410 and secondary image files 412 may be of any of a number of types of video or still image files. Each of the first and secondary image files may each be of different lengths, video qualities, themes, video sizes or other parameters, but are preferably of the same width in pixels. In the heterogeneous catalog of first and secondary image files in database 108, a final movie may be created such that any primary image file may be shown with any secondary image file in skin 200B. Because the two movies are independent of each other both types of image files may be also viewed independently of the other using an appropriate player with access to the correct URLs.

A final movie in skin 200B may directly access any of the primary and secondary image files stored on an RTSP server, or streaming live, and provide them to device 108. However, because an embodiment utilizes a reference movie, or reference movies to act as a pointer(s) to the image files, the content of the image files may be easily changed. In the art, a reference file is also known as a pointer, reference or client movie. The reference file is a (small) MOV file that contains metadata that is essentially a request for data from a URL. The pointer is used to fetch the relevant primary or secondary image file. Reference files can be loaded quickly. Reference files and the image or movie files that contain them may be stored on TCP servers with the traditional elements of a webpage. When a movie is activated to be played, instructions are sent from the player to stream data from the RTSP server.

As a comparable to computer programming concepts, a reference movie can point to a plurality of movies (image files), without changing the pointer itself, provided there is a file on the appropriate server that bears the name the reference movie is looking for. In an embodiment, the reference movie provides a command to retrieve data identified in the related URL. Additional features that can be added to the movie that contains the reference movie including customized player skins, hyperlinks to other Internet content, chapter points, etc., or other content or data which is not streamed. For example, static elements, such as skins controllers, etc., may be downloaded or activated on when the multimedia player is launched. Such elements remain dormant until they are activated to issue a command. For example, the “Pause” element operates in this manner.

To create a reference image file (i.e., reference movie), for example, QuickTime Pro (trademark) may be used. In this instance, a reference movie file is created in QuickTime Pro player by loading a movie by inputting its URL then saving the link to the .mov file as a reference movie using the “Save As A Reference Image file” function. Alternatively, facilities in the QuickTime tool MakeRefMovie may be used to generate pointer files for image files. Using a movie created in MakeRefMovie, the URL of an image file (primary or secondary) can be input and a file saved as a .MOV file. The MakeRefMovie function may create movies for various Internet connection speeds, CPUs, languages, and more. The file thus saved is a reference image file or movie that when played will go to the appropriate RTSP server and instruct that the movie at that URL be played. It will be appreciated that creation of a reference image file may be automated by creating and executing scripts that are fed to QuickTime Pro.

Using either process or other techniques known to those of skill in the art, two image files may be streamed independently of each other. However, an embodiment provides a single media player skin that issues URLs for a primary and secondary movie and plays both the primary and secondary image files simultaneously. While the viewer selects only the primary movie, the embodiment allows the underlying server to select and identify an appropriate secondary image file that must be viewed with the primary movie. In order to provide a single multimedia play of both movies, a “final” movie is created in an embodiment that is able to request both the primary image file, representing a movie that a viewer has requested, plus a secondary image file, providing third party messages, and play them simultaneously. It will be appreciated that the term “final” movie is meant to describe the last step in what is a series of steps or movie or image file creation. The production of the final movie is the last step in creating and linking a series of ‘nested’ movies. Effectively, the final movie temporarily binds the primary image file with the secondary image file. The secondary image file may consist of video only, but an audio track used to tag the presentation may be included that will play after the primary movie has ended. The final movie, which is downloaded from a TCP server, should contain all elements that compose the final presentation plus the pointer movies that will point to the image files that will be streamed to device 108, such as a custom skin or other elements.

The “final” image file preferably utilizes the reference movies to request the images files. The tool LiveStage Pro (trademark), a tool used to author interactive and multi-track QuickTime movies, may be used to create the final movie. To create a final movie in LiveStage Pro, a project is created, named and saved. Creation of a project also creates a master directory and sub-directory where elements needed to create the final image file are copied to and stored, including the two reference image files.

Authoring facilities in LiveStage Pro (trademark) may be used to set parameters for the movies, including: dimensions of the player skin; and saving restrictions (if any) for the video. Additionally, the two reference movies may be embedded into the final movie; and/or the URL locations of the primary and secondary image files that are played within the skin may be directly provided within the authoring facility.

Exemplary steps are now described in creating the final movie using facilities in LiveStage Pro (trademark) for an embodiment. First, references to the primary and secondary image files are set into place in the authoring interface of LiveStage Pro. Both the video and audio tracks and their respective hinted tracks may be displayed in the authoring window and are preferably left in an active state.

As an alternative, the primary image file may be authored as a progressive download in the final movie. In such a case, a pointer movie may not be required. Instead, the entire primary image file may be loaded into the library of LiveStage Pro and placed to the authoring window. A pointer may be used it initiate a progressive download.

It will be appreciated that the image files may be set in layers, using a layering function in the authoring tool. The primary and secondary image files may be set to appear on the same layer, such as Drawing Layer 0 in QuickTime. Alternatively, the primary image file may be set at a higher priority layer over the secondary image file.

Next, the relative positions of the two image files are set for playback in the multimedia player skin. In QuickTime (trademark), for the primary image file, its top left hand corner of its image is set to occupy the 0, 0 (x, y) location. For the secondary image file, its top left hand corner of its image is set to be in the second region 208. Referring to exemplary skin 200B in FIG. 2B, secondary image file is anchored at the 0, 240 (x, y) location. Depending on the dimensions of the primary image file, such as for a letterboxed primary movie, the size of the media player and the positioning of the secondary image file on the x, y locations may be adjusted accordingly. Ancillary messages may be embedded in the skin of the player.

Once the above settings have been made, the final image file may be exported to create loadable code that will modify the skin if required, or the embedded multimedia player and then send the appropriate URLs to the RTSP server. In LiveStage Pro (trademark), this may be accomplished using the “Export Wired Image” function. The result is a composite file that includes references to the primary and secondary image files.

Next, the final image file is uploaded to server 104 and the web page modified to request it via a URL to allow it to be referenced from a webpage and downloaded from server 104. The final image file may be provided as either a hyperlink or as an embedded image file. The final image file is typically small and can be loaded quickly by the website. The multimedia player software may provide additional controls relating to the level of amount of interactivity with the functionality of the multimedia player and primary and secondary image files that will be provided to the viewer. For example, the ability to jump through the presentation may be limited. When the RTSP server is accessed by device 108, hinting tracks and other information are provided to device 108. A user at device 108 may access the final movie by activating any related hyperlink button. Alternatively, the final movie may be associated with a predetermined page in the website and may be automatically played when that page is accessed.

When a request is made to download the final image file, the two reference image files contained therein immediately retrieve their respective primary and secondary image files and the two image files are streamed independently and simultaneously to device 108. However, skin 200B provides what appears to be a single image composed of the primary and secondary image files.

The final movie, as created, provides a template for creating other final movies presenting different or the same primary and secondary image files. It will be appreciated that by using reference movies in the final movie, server 104 needs to have primary and secondary image files identified by the same names used by the reference movies contained in the final movie. As such, it will be appreciated that swapping of image files on the RTSP server may be quickly executed. For example, a current secondary image file (having one advertisement) may be replaced with a revised secondary image file (having another advertisement) by renaming the revised secondary image file to the name of the current secondary file. The current secondary file may be renamed, moved, and/or archived, offline, as needed. The names of the first and secondary image files may follow required naming conventions for the operating system of server 104. If a particular file cannot be found or is corrupted, then the operating system may generate an error message and/or a default image file may be loaded providing a message that is displayed on the viewer's device screen indicating the status of the file. Additionally or alternatively, the primary image file may be swapped.

A final movie, as a template, allows matching and mating of a primary image file to a second image file depending on any predetermined parameter. As such, issues with differences in time of movies, formats and localization issues may be controlled through selecting and matching primary images files to second movie files as per any predetermined parameters or requirements, and saving the final movies with an appropriate name that can be addressed as a URL using standard web browser art. For time issues, a template may be constructed to match a primary image file to a second image file of the same length from the library. For format issues, a template may be constructed to provide primary and secondary image files having dimensions, output qualities or other quality or sizing parameters for downloads intended for mobile devices 108, downloads relating to letter-boxed sized images, downloads for low-speed connections, etc. For localization issues, an advertiser may wish to provide different geographic territories with different messages, pay for advertising from different territorial budgets or advertise in selected territories when the content is offered globally. Other localization parameters may be required by the advertiser. As IP addresses provide some geographic origin information when a website is accessed, a set of templates may be created to link a particular primary image file with different secondary image files, based on regions. As such, a template can be provided for specific regions, such as North America, United States only, Canada, Europe, etc. Similarly, other templates can be provided to address specific targeting requirements for an advertisement as required.

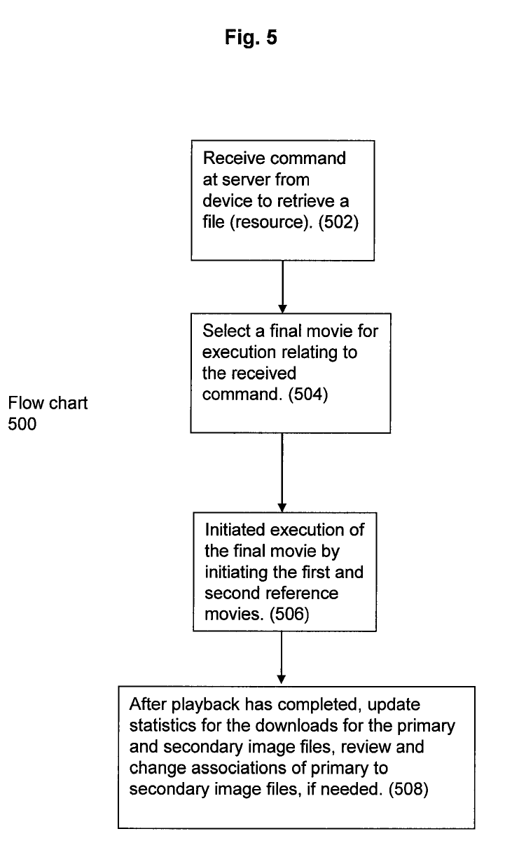

Further detail is now provided on processed operating in server 104 (FIG. 4) to identify and execute a final movie to provide primary and secondary image files to a requesting device. The final movie can be seen as being a template and resource that is used to access the primary and secondary image files. Referring to FIG. 5, flow chart 500 provides an outline of a process that is executed on server 104. First, at step 502, a command has been received by server 104 from device 108 to retrieve a file. The command may be a URL. At step 504, a final movie (as described above) is selected for execution, relating to the received command. The final movie may be selected from a number final movies offered to the viewer as a list on the website. As such, this allows further customization of the first and second image files that are provided to device 108. As noted earlier, the image files may be selected to account for the current location of the device or the display capabilities of the device. At step 506, the selected final movie is initiated. Therein after, it sends a request for the primary and second movies referenced using the pointer movies created in QuickTime Pro or MakeRefMovie and authored into the final movie using Live Stage Pro. The RTSP server locates the primary and secondary movies as named and then the image files begin streaming to device 108. The multimedia player may or may not respond to playback controls provided from device 108 (e.g. pause, fast forward, rewind, start, end) as presented in section 206 (FIG. 2B). Once the playback has completed, at step 508, updates are provided to the statistics for the viewings of the primary and secondary image files. At that time, additional amendments may be provided to change content of secondary image files and primary image files. This may include constructing new reference movies, and consequently new final movies, but primarily of changing the content of primary or secondary image files, by uploading new files and assigning them the names the pointer movies will reference. It will be appreciated that step 508 may be implemented as a background process that is driven by continually updating statistics. As a secondary image file may contain multiple advertisements, the accounting procedures may track statistics for each advertisement in the file. As noted earlier, statistics module 408 tracks website traffic and advertisement downloads.

Further detail is now provided on an exemplary access session by a viewer at device 108, when accessing an exemplary portal website providing music video files according to an embodiment. It is presumed that device 108 has a website browser installed thereon. The viewer would access the website, which would provide a GUI that presents a menu of music videos available for streaming to device 108. The viewer selects a title for streaming through the GUI.

Next, the browser launches a viewing program stored, such as QuickTime, which then creates a player in a new layer window in the GUI or may go to a page with the viewer embedded. Server 104 then downloads the selected video which is sized to fit into the player.

Before the video is started, certain functionalities and parameters for the video may be set. For example, if the video has sprites, then parameters are set to allow them to be presented. Also, specific functions may be selectively de-activated for the player, e.g. the player can be set to disable cancelling of a track. Once these parameters are set, the player generates and sends two URL requests to the server, one for each image file. Preferably, the servers are streaming servers.

As such, the URL requests are directed to an RTSP server for files with specific names. If a file is located on server 104 having the requested file name, server 104 may begin to stream the content of that file. Successful initiation of a stream for a file is predicated on a number of some assumptions, including: a) that the content has been encoded using a compression algorithm that the player can decompress; b) that the content will be streamed according to a protocol understood by the player; c) that the file is hinted.

When server 104 locates the movie, it streams data from it to the network in data packets of audio and video data. The data packets are provided to the player without being stored on device 108 in a “permanent” fashion. For a video image, a frame may be presented on a screen in the player for about 1/30 of a second. The next frame replaces the current frame, without saving the current frame. Once the movie has played and the player is closed, the viewer may then initiate another request for another video.

Other features may be provided to match secondary image files to the primary image files. For example, meta data relating to device 108 (and ultimately to the viewer using device 108) may be provided to server 104. The meta data may be provided through an applet or application operating on device 108 in conjunction with the website that extracts the meta data and provides it to server 104. The meta data may include some geographic data relating to device 108. Cookies and log data preferably stored on device 108 may provide additional data and meta data relating to device 108 and its associated viewer. As such, when the viewer at device 108 selects a primary image file (movie) from the website, the meta data may be used to identify a specific image file to be associated with the primary image file. The secondary file may be preselected based on demographic data associated with the viewer at device 108. Pointers to the primary and newly identified secondary image file may then be saved into a final movie (as described above) and then the final movie would be executed and streamed to device 108. This system would facilitate customizing a final movie to include a secondary movie that matches the viewer's demographics, as provided by the meta data.

Further detail is provided on how image files may be constructed and modified for database 106. As noted, server 104 is used to store a collection of video files. The files may be of any type of quality suitable for the Internet, and may be compressed and may have sound or not. Typically, the files may be in a variety format suitable to the most popular multimedia players.

As noted the primary image file is the target video file to be viewed. The original video file may require some minor editing. Video editing software, such as Final Cut Pro (trademark) or Adobe Premiere (trademark) may be used to generated a final format of a video in an image file. The editing software may be used to delete extraneous frames at the head and tail of the video clip. One or more black frames may be added at the tail as the last frame of the image file which will allow a black freeze frame to be displayed at the end of the video until playing of the video is terminated. A letter-boxed video provided in a 16:9 format which would result in black bands across the top and bottom may be cropped to reflect letterbox dimensions. This clip may be then named and exported as uncompressed an .AVI or .MOV file. The editing may be done off-line prior to compression and further authoring.

As noted earlier, video files (i.e. primary image files) may be streamed from server 104. Server 104 is implemented as a streaming server. Streaming servers are different than the web servers that store and deliver static website content. In order to stream video and audio, it is typically compressed, similar to content for progressive downloads. Additionally, a hinted track for each of the audio and video tracks is preferably provided. As is known in the art, a hinted track provides information to the server in parallel with the related audio/video track, including data that identifies keyframes (for still pictures) and data that provides information on how the stream is encoded and/or packetized. Video compression software, such as Sorenson Squeeze (trademark), or editing software such as QuickTime Pro, Adobe Premiere, Apple Final Cut, Windows Media Player Encoder (all trademarks), etc. may be used to convert a either a compressed or uncompressed video file to a video file hinted for streaming. The compression and hinting software may be operated on server 104 or the video file may have been process through a compression software program offline prior to loading on server 104. Many output parameters of the video file may be set by the author using the software, including the compression codec, screen dimensions in pixels, the frame rate, bit rate, etc. The parameters may be set to conform to operating and display characteristics of the target device 108. For example, different sizes of videos may be set for a mobile device or different displays for a computer.

Some files may be uploaded that are compressed but not hinted, where recompression may be conducted separately prior to uploading the files to servers 104. Servers 104 may then provide the files as progressive downloads.

The output hinted image files may be named and loaded to server 104 or a collection of servers 104, as per the database design of server 104. The names of the files may be provided to conform with any file naming protocol for final movies, pointer movies, RTSP server hyperlinks, database management, etc. Typically, once the movie file is uploaded and a URL for the content has been established, the name of this file cannot be changed, although the content can be. Additional information relating to the primary image file may be included in the file name or a separate related sub file may be created. The naming convention may also apply to final movies and the conventions will be inter-related to meet specific needs of content owners and advertisers. Thus, the information in the file name may include geographic information, output formats, source information or other data. This information may be accessed when determining how and when to use a particular first image file and to identify appropriate secondary image files for it, as described above.

Once the hinted file is provided to server 104, it may be streamed to any device 108 that is connected to server 104. To access the file, device 108 would need to provide an appropriate URL into a “USE URL” command call from a multimedia player operating on device 108.

The secondary image file may be generated for use on the server 104 using the comparable video editing software as those described above. In generating the secondary image file, its viewing dimensions need to be determined and set such that it would preferably fill the region 208 in skin 200B. As such, in skin 200B, the secondary image file should preferably have dimensions of 320×60 pixels. Again, uncompressed, or minimally compressed, digital content in .MOV, AVI or other formats that has been sized for skin 200B is then processed by the compression and hinting software.

One or more secondary image files or video clips may be combined to build a composite secondary image file that provides a slide show like effect of what appear to be different static slides and video clips, although they are in fact a movie at 10-30 fps. The running time of the composite secondary image file may be set to any length, but it is preferable that the length be timed to aligned with the duration of a target primary image file.

Following is an example of how a composite secondary image file may be created. If an advertisement is provided as a static .JPG file of a corporate logo, with or without a short slogan, at the appropriate dimensions, such as 320×60 pixels, it is possible to create a composite secondary image file, using a video editor such as Adobe Premiere or Apple Final Cut, where first one .JPG file is presented for a predetermined length of time, then another .JPG file is presented, and others as the case may be. This composite of jpgs is output from the video editor in what is essentially a movie, which can be compressed, hinted and ultimately streamed. As an example, a 3 minute secondary image file may be created consisting of a loop, or replication in consecutive order of the logos of four advertisers. Each logo is provided with roughly the same amount of presentation time in the composite secondary image. The composite image file may be a collection of composite image files. For example, a 1 minute image file may be created where each logo is displayed consecutively in 15 second slots. Thereafter, the 1 minute image file may then be replicated, once and twice to create the 3 minute file. The composite image file may additionally or alternatively have a fifth .JPG at the end with a closing statement banner providing any additional information from an advertiser or from the website host. For example, an invitation may be provided to invite the viewer to tell friends about the portal. Additional information relating to the advertisements stored in a particular secondary image file may be included as a tag in the file or a separate related sub file may be created. This information may be accessed for accounting purposes, as described above.

When all the visual elements are in place and are correctly timed, the content for second movie may be exported as an uncompressed .AVI or .MOV file and then imported into the compression and hinting software to produce an image file that has parameters that are compatible in terms of width with the primary image file. Such parameters may include compression rates, bit rates, dimensions etc. If necessary, the output file may be renamed according to the convention and uploaded to the same or a different RTSP streaming server.

It will be appreciated that the embodiments relating to devices, servers and systems may be implemented in a combination of electronic hardware, firmware and software. The firmware and software may be implemented as a series of processes and/or modules that provide the functionalities described herein. Data may be stored in volatile and non-volatile devices described herein and be updated by the hardware, firmware and/or software. Other network embodiments may use non-client server architectures for management of communications. Much of the process may be automated via scripts or other programming techniques or modules.

It will be appreciated that in other embodiments, an alternative system may have other preset routines to collect and present primary image files and secondary image in a viewer, where pointers may be used, but not necessarily in the manner described above. In particular, the preset routines would include a selection routine that accesses the primary and secondary files directly, without the use of a pointer mechanism.

The present invention is defined by the claims appended hereto, with the foregoing description being merely illustrative of embodiments. Those of ordinary skill may envisage certain modifications to the foregoing embodiments which, although not explicitly discussed herein, do not depart from the scope of the embodiments, as defined by the appended claims.

1. A method for providing a primary image file with another image file, said method comprising:
providing to a network an access link for a resource that relates to the primary image file;
receiving from a remote device in the network a request for the access link;
from the resource, locating and providing the primary image file to the device for display in a first area of a window in a display on the device;
from the resource, locating and providing a secondary image file associated with the primary file as identified in the resource to the device in a second area of said window; and
updating access statistics relating to the secondary image file based on the request for the access link.

2. The method for providing a primary image file with another image file as claimed in claim 1, wherein said resource is a reference movie providing a link between to primary image file and said secondary image file.

3. The method for providing a primary image file with another image file as claimed in claim 2, wherein said primary and secondary image files are streamed independently to said device.

4. The method for providing a primary image file with another image file as claimed in claim 3, wherein said secondary image file is streamed simultaneously with said first image file to said device.

5. The method for combining a primary image file with another image file as claimed in claim 4, wherein said resource contains a first pointer to a first file name for said primary image file and a second pointer to a second file name for said secondary image file.

6. The method for combining a primary image file with another image file as claimed in claim 5, wherein said resource is a Uniform Resource Locator (URL).

7. The method for combining a primary image file with another image file as claimed in claim 6, further comprising replacing said secondary image file with an alternative secondary image file as accessed by said resource by renaming a third file name for said alternative secondary image file to be said second file name.

8. The method for combining a primary image file with another image file as claimed in claim 7, wherein said alternative secondary image replaces said secondary image file when meta data associated with said device indicates that said alternative secondary image matches a predetermined parameter for linking said secondary image file to said primary image file.

9. A server for providing a primary image file with another image file through a network to a requesting device, said server comprising:
a first module to access a database storing primary image files, secondary image files and resources providing links among said primary and secondary image files;
a second module for
providing to said network an access link for a resource of said resources that relates to the primary image file; and
processing a received request for said resource from a remote device in said network by
identifying the primary image file from said primary files relating to said resource;
identifying a secondary file from said secondary files that is to be associated with said primary image file as identified in said resource;
providing said primary image file to said device for display in a window on a display of said in a first area of a window for a display of said device; and
providing said secondary image file to the device for display in a second area of said window;
and
a statistics module for tracking traffic statistics related to said primary files and said secondary files.

10. The server as claimed in claim 9, wherein
said resource is a reference movie providing a link between the primary image file and said secondary image file; and
said second module streams said secondary image file to said device independently and simultaneously from said first image file.

11. The server as claimed in claim 10, wherein said resource contains a first pointer to a first file name for said primary image file and a second pointer to a second file name for said secondary image file.

12. The server as claimed in claim 11, further comprising
a third module for managing associations for said resource and for selectively replacing said secondary image file with an alternative secondary image file as accessed by said resource by renaming a third file name for said alternative secondary image file to be said second file name.

13. The server as claimed in claim 12, wherein said third module replaces said secondary image file with said alternative secondary image when meta data associated with said device indicates that said alternative secondary image matches a predetermined parameter for linking said secondary image file to said primary image file.

14. The server as claimed in claim 12, wherein said third module replaces said secondary image file with said alternative secondary image when statistics from said statistics module indicates streamings of said secondary image file has exceeded a predetermined threshold.
